(19) United States
(12) Patent Application Publication
(10) Pub. No.: US 2003/0196084 A1
(43) Pub. Date: Oct. 16, 2003

(54) System and method for secure wireless communications using PKI

(76) Inventors: Emeka Okereke, Upland, CA (US); Robert Thacher, Newport News, VA (US); Justin Good, Upland, CA (US)

Correspondence Address: Thomas F. Bergert, Williams Mullen, PC, Suite 700, 8270 Greensboro Drive, McLean, VA, 22102, US

(21) Appl. No.: 10/412,563

(22) Filed: Apr. 11, 2003

Related U.S. Application Data
(60) Provisional application No. 60/371,736, filed on Apr. 12, 2002.

(51) Int. Cl. H04L 9/00

(52) U.S. Cl. 713/156; 380/270

(57) ABSTRACT

A system and method for allowing users of wireless and mobile devices to participate in Public Key Infrastructure facilitates secure remote communications. The present invention allows wireless devices to participate in secure communications with secure networks without storing compromisable information on the wireless device. In one embodiment, the system allows wireless devices to participate in Public Key Infrastructure wherein no portion of the certificate, no information about the certificate, and no private or public key data are stored on the wireless device. In one embodiment, a certificate proxy server maintains the digital certificate and private for the client device in a secure fashion, and maintains connectivity with the wireless network. The mobile user can authenticate with the server in order to access resources that require the certificate to be presented.

### CROSS-REFERENCE TO RELATED APPLICATIONS

This application claims priority under 35 USC 119(e) of U.S. Provisional patent application Serial No. 60/371,736 filed on Apr. 12, 2002, entitled “System and Method for Secure Wireless Communications using PKI” which is hereby incorporated by reference in its entirety.

### TECHNICAL FIELD

The present invention relates to the field of mobile communications, and more particularly to the security of mobile communications using Public Key Infrastructure (PKI).

### BACKGROUND ART

Both private and public entities rely on information technology systems to perform essential or mission-critical functions. Some computer information, such as defense, financial, medical, and personnel data, is sensitive and merits special or additional protection against unauthorized use or disclosure. As information technology becomes increasingly distributed and interconnected, the consequences of losing control of information become greater. For example, systems that perform electronic financial transactions or electronic commerce must protect against unauthorized access to confidential records and unauthorized modification of data. Sometimes, the value of the information lies in its limited distribution; wide spread knowledge and misuse could reduce the value of that information. In other cases, release of the information could lead to extrinsic harm, such as a violation of personal privacy. Easy access to sensitive information may also lead to malicious corruption of the information. Yet the distributed, collaborative, and open nature of early networks, including the Internet, encouraged the free flow of information in a manner that is not suited to information control.

Information security refers to those measures taken to protect information against unauthorized disclosure, transfer, modification, or destruction. Instead of returning to closed networks, computer security managers are seeking information security through reliably secure or trusted computer systems and communication methods. Both government and industry face a growing public concern for privacy, and the need for effective information security is compelling. At the same time, users want easy access to information from a variety of access devices, including desktop computers or workstations, as well as remote wireless devices.

Both wired and wireless information security systems seek to ensure authentication, confidentiality, non-repudiation and integrity in communications. Wireless systems must also deal with inherent issues of limited bandwidth, high latency, and unstable connections.

Some have employed PKI (public key infrastructure) as a means to increase information security. PKI enables users of a basically insecure network such as the Internet to securely and privately exchange information through the use of a public and a private cryptographic key pair that can be obtained and shared through a trusted authority. The public key infrastructure provides for a digital certificate that can identify an individual or an organization, and directory services that can store and, when necessary, revoke the certificates. A public key infrastructure consists of: (1) a certificate authority (CA) that issues and verifies a digital certificate, which includes the public key and/or information about the public key; (2) a registration authority (RA) that acts as the verifier for the certificate authority before a digital certificate is issued to a requester; (3) one or more directories where the certificates with their public keys are held; and (4) a certificate management system.

With PKI, a public and a private key are created simultaneously using the same algorithm by a certificate authority. Information encrypted with the private key can only be decrypted with the corresponding public key. Similarly, information encrypted with the public key can only be decrypted with the corresponding private key. The private key is given only to the requesting party and the public key is made publicly available as part of a digital certificate in a directory that all parties can access. The private key is never shared with anyone or sent across the network. In addition to encrypting messages for privacy assurance, authentication of the sending individual is possible if, for example, the individual uses their private key to encrypt a hash of the message contents. A hash results from the transformation of a string of characters into a usually shorter fixed-length value or key that represents the original string. For example, if user A is sending a message to user B, user A can use B's public key to encrypt the message, and can use A's own private key to encrypt a hash of the message contents. User B can decrypt the message with user B's own private key, and can decrypt this hash using user A's public key, thus authenticating user A as the sender of the message.

The ordinarily skilled individual in this field will recognize the pertinent features surrounding PKI technology. The working paper “Internet X.509 Public Key Infrastructure: Roadmap”(http://www.ietf.org) provides a detailed overview of PKI technology and is hereby incorporated by reference.

Several forms of public key infrastructure exist, including the WPKI for wireless devices. There also exist specialized PKI implementations for constrained storage devices such as smart cards. Current efforts aimed at allowing wireless devices to participate in Public Key Infrastructure operate so as to:

1] store the entire certificate and private key on a wireless device in an unprotected fashion; or

2] store the entire certificate and private key on a wireless device in a protected fashion; or

3] store a digest or hash of the user's certificate solely for ID purposes on a smart card or similar constrained device, for example, and authenticate against a specialized security server.

None of these efforts completely address the security risk posed by theft or loss of the wireless device. For example, in the case where the entire certificate and private key is stored on a stolen wireless device in an unprotected manner, the thief can then access the formerly secure information through the compromised device. The thief can also copy the certificate and private key to another device for later use.

### SUMMARY

The present invention allows wireless devices to participate in secure communications with secure networks without storing compromisable information on the wireless device. In one embodiment, the system allows wireless devices to participate in Public Key Infrastructure wherein no portion of the certificate, no information about the certificate, and no private key data are stored on the wireless device.

### BRIEF DESCRIPTION OF DRAWINGS AND FIGURES

FIG. 1 shows a traditional PKI.

FIG. 2 shows a standard wireless PKI.

FIG. 3 shows the wireless infrastructure in accordance with the PKI system of the present invention.

FIG. 4 is a diagram showing information flow associated with initialization of a device in accordance with the present invention.

FIG. 5 is a flow chart showing how a wireless device can be initialized for use in accordance with the present invention.

FIG. 6 is a flow chart showing how an initialized device operates to access secure resources in accordance with the present invention.

### DESCRIPTION OF THE PREFERRED EMBODIMENTS

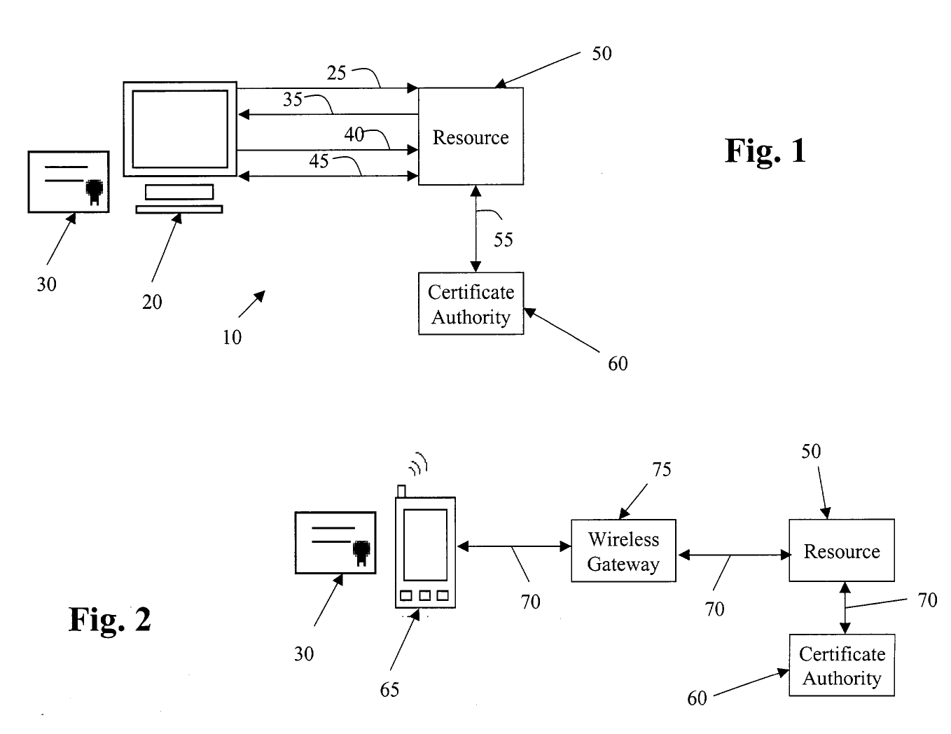

As shown in FIG. 1, there is provided a traditional PKI system 10. The end user from the client workstation 20 sends a request 25 for a secure resource 50, and before access is granted, the user is requested 35 to provide a digital certificate 30 for authentication. The secure resource can be data, applications or other information of value. In some cases, once the digital certificate 30 is provided 40 and verified 55 by a certificate authority 60, access to the secure resource 50 will be granted as at 45. In other cases, an additional form of authentication may be required, such as a user name and password, a smart card, or a fingerprint, for example. The digital certificate verification process occurs through a certificate authority 60, normally a trusted third party.

In the wireless context, as shown in FIG. 2, the request for secure resource is made by wireless device 65 through a wireless gateway 75, and similar communications 70 for authentication, verification and resource access ensue using certificate 30.

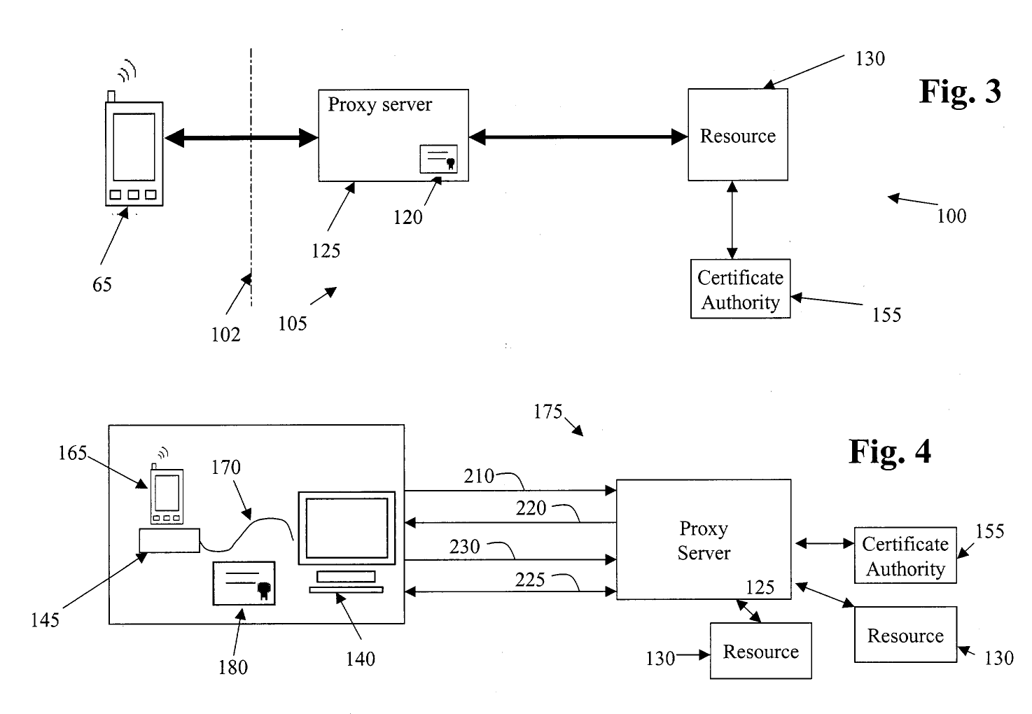

In the system 100 of the present invention, as embodied in FIGS. 3 through 6, the user's digital certificate 120 is maintained on a proxy server 125 located within the system network identified at 105. As shown in FIG. 3, the user can use wireless device 65 to establish connection with proxy server 125 within secure network 105, and access secure resources 130 through the proxy server. A certificate authority 155 is also provided in communication with the network for certificate authentication purposes.

In a specific embodiment as shown in FIG. 4, the user is first provided with a network-connected device, such as a desktop computer 140, along with one or more docking stations 145. One or more wireless-capable devices 165 may be docked in the docking station for two-way communication with the desktop computer as indicated at 170. The desktop computer includes a memory, processor, user interface, keyboard and mouse as is commonly known, and is preferably connected to a local area network (LAN) 175 for communication and use of shared resources as is commonly known. The user may be provided with a system PKI certificate 180 and private key for use with the desktop computer, in order to access and communicate to the extent authorized by the network administrator. As shown in FIG. 4, a certificate proxy server 125 can be placed within the system network in accordance with the present invention to provide for secure communications between and among the desktop computer 140, the wireless device(s) 165, the system resources 130 available on network 175 and a designated certificate authority 155.

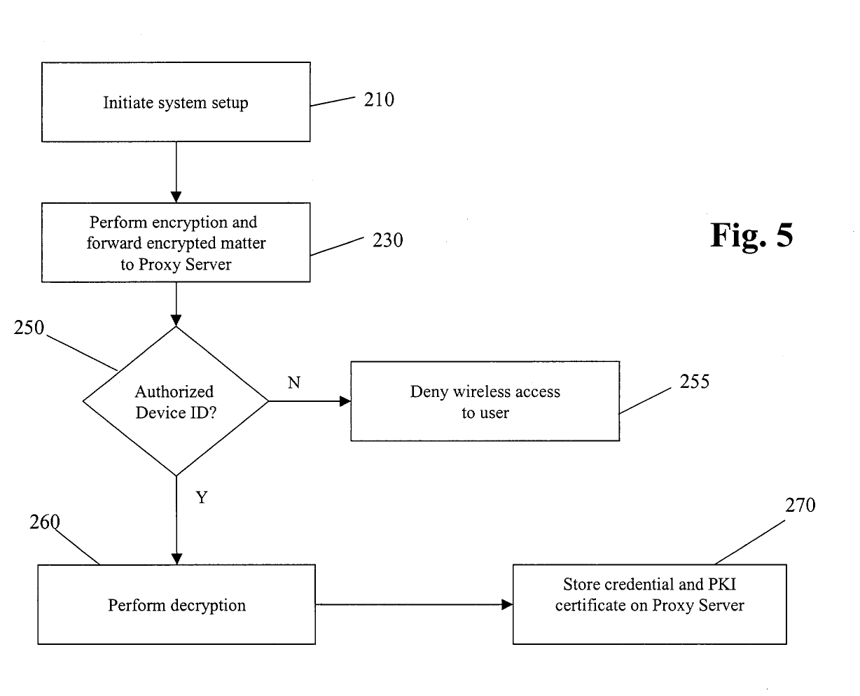

The establishment of mobile access to secure resources in accordance with the present invention can occur as shown in FIGS. 4 and 5. The proxy server can be provided with software designed in accordance with the present invention, and a thin client application can be installed and/or downloaded onto the user's desktop computer. The proxy server program then awaits the initiation of a request 210 from the desktop to establish secure wireless access capabilities using the system of the present invention. In so doing, a unique identifier for the wireless product to be employed is passed as at 210 to the proxy server 125 program for authorization. The wireless product 165 can be a personal digital assistant (PDA), laptop, cellular telephone or any other device capable of remote wireless communication. The unique identifier can be a serial number or SIM. number, for example. If the unique identifier is one which the proxy server program identifies as being acceptable, the proxy server program will send approval as at 220 to the desktop 140, which executes functionality to make a key exchange as at 225, such as, for example, a Diffie Hellman Key Exchange. This key is used to encrypt information sent to the server using AES (Advanced Encryption Standard). AES is an encryption algorithm used by U.S. government agencies for securing sensitive but unclassified communications. In the preferred embodiment, this key is used to encrypt communication between the desktop and the server. In another embodiment, this key is used as part of a shared secret between the server and the client. This shared secret is used to generate a session key. The new session key ensures that conversations cannot be eavesdropped if the key has been compromised. The shared secret eliminates the possibility of a man-in-the-middle attack.

The wireless device 165 is provided with a memory, processor, and input/output means as is commonly known. Using the session key, the user can then encrypt credential information, its PKI certificate 180 and private key, and forward this information to the proxy server 125 as at 230 in FIGS. 4 and 5. In one embodiment of the invention, the encrypted information is sent to the proxy server via secure IP network. The credential information or authentication measure can be something the user has (such as a swipe card), something the user is (such as represented by a fingerprint scan), or something the user knows (such as a password or pass phrase). In one embodiment, the credential information is a user name and password. In another embodiment of the invention, the credential information is a random number generated by programming on the wireless device, wherein the number changes in predetermined time intervals and is synchronized with programming on the proxy server so as to always match the corresponding number maintained on the proxy server.

Regardless of form, the credential information is forwarded to and stored on the proxy server, as at 230 in FIG. 5. If the device is an authorized device by virtue of appropriate identification provided and as determined at 250 in FIG. 4, the credential, PKI certificate and private key is decrypted as at 260 and the proxy server stores the credential, certificate and private key in a directory on the proxy server as at 270. No PKI certificate, or public or private key information is ever passed to or stored on the wireless device. If the device is unauthorized, as determined at 250, access is denied as at 255.

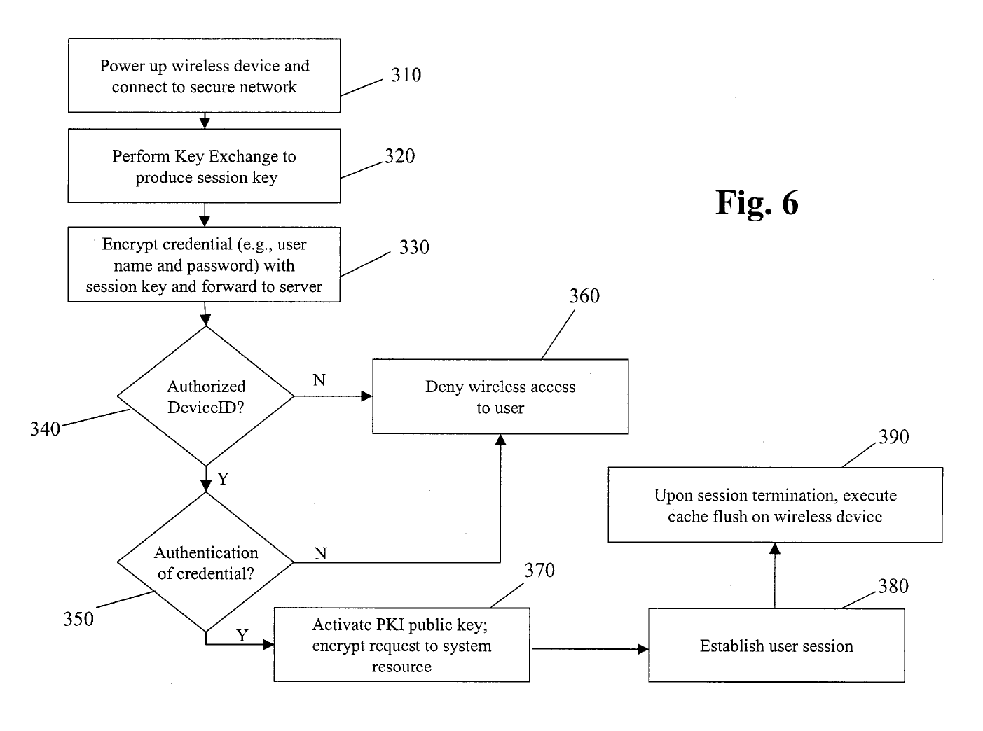

As shown in FIG. 6, when the user attempts to access the system network through the wireless device as at 360, the proxy server first authenticates the user. This can be, in one embodiment, with a two-form authentication, such as with a user name and password, smart card, or biometric identification, for example. In one embodiment, as shown in FIG. 6, a session key is produced as at 320 and the user's credentials are encrypted with the session key and forwarded to the server as at 330. If the user is authenticated by the proxy server matching the device unique identifier with authorized device identifications as at 340, and the credential information is authenticated as determined at 350, the proxy server will activate the user's PKI public key and request the secure network resource for the user, as at 370. If the device identification is not authorized, or the user's credential is not authenticated, access to the user will be denied as at 360. The proxy server will then receive the request for digital certificate and private key, and provide the previously stored digital certificate and key, which can then be validated by the certificate authority, and the user's session can begin.

The user's information access capabilities during any given session can be determined by the network/resource administrator. For example, the user may have access to a Global Access Lookup directory for identification and contact information of others. When such information is presentable in browser-recognizable format, the appropriate page may be sent to the proxy server in HTML format, for example, and the proxy server can invoke programming functionality, which then pushes the same information to the wireless device.

The user can ensure secure communication between the wireless device and the Certificate Proxy Server (CPS) in various ways, including physically connecting the device to the server, or connecting securely over a known trusted network. As the user's certificate and private key are securely transferred to the CPS, the unique network identifier for the user's wireless device (such as a SIM number) is registered with the server. This network identifier registration can also be done in a number of ways, including over the wireless network, or over a physical network.

In order to begin using the system via wireless device, the user may be required to provide additional forms of authentication to the CPS, such as a password or biometric signature. When the user is authenticated, a secure channel is established between the device and the CPS. All user requests to access secure resources are then handled via the CPS, which presents the appropriate user's certificate on their behalf as required.

In one embodiment of the invention, desktop software is used to authenticate the user to the CPS, register the wireless device with the CPS, facilitate the initial key exchange and transfer the certificate and private key to the server. When the user wishes to access a resource from the wireless device outside of the secure network demarcation line (102 in FIG. 3), they are prompted for a second means of authentication, which may be something the user has (such as a swipe card, synchronized password keychain or channel key, for example), something the user is (such as a fingerprint scan), or something the user knows (such as a password or pass phrase). In a preferred embodiment this second form of authentication is something the user knows. The CPS verifies both forms of authentication, locates the user's certificate and establishes a session.

In this way, the PKI is extended into the wireless domain without exposing the private key on the wireless device. Once a session is established, the CPS handles all interactions with entities that wish to authenticate the user. In the preferred embodiment, the CPS is capable of handling all wireless requests, including establishing and terminating a session, and general information requests.

In one embodiment of the invention, wireless access to the proxy server is not through a port in the network firewall, but rather through a separate private network connection, such as a leased line providing X.25 or IP over frame relay connectivity, for example. It will be appreciated that the network communication protocols can be varied without affecting the spirit or nature of the present invention. In one embodiment of the invention, once the user's session is complete, the proxy server can act to remove all locally cached information from the user's device for added security through conventional means, such as through a “cache flush” or “clear cache” instruction.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A method for providing secure mobile communications, comprising the steps of:
(a) providing a secure network having a proxy server;
(b) initializing a wireless device within said secure network, said wireless device being associated with a user, said user having an associated digital certificate;
(c) storing said user digital certificate on said proxy server; and
(d) providing remote access to said secure network via said wireless device over an insecure network by transmitting at least two forms of authentication from said wireless device to said proxy server, said at least two authentication forms not to include a digital certificate, a portion of a digital certificate or a hash of a digital certificate.

2. The method of claim 1 wherein the user is further provided with a private key and wherein step (c) includes the step of storing said user's private key on said proxy server.

3. The method of claim 1 including the further step of (e) clearing said device of locally cached information.

4. A method for providing secure mobile communications from a user's wireless device, comprising the steps of:
(a) storing user-associated information, including at least one digital certificate, on a proxy server;
(b) receiving a request from said device to access secure information accessible via said proxy server;
(c) authenticating the user of the wireless device to the server using at least two authentication measures; and
(d) servicing said request from the wireless device via the proxy server.

5. The method of claim 4 including the step of (e) removing all locally cached information from the wireless device.

6. The method of claim 4 wherein step (d) includes the step of presenting the user's certificate to at least one additional server.

7. The method of claim 4 wherein said at least two authentication measures in step (c) include a user-possessed authentication measure.

8. The method of claim 4 wherein said at least two authentication measures in step (c) include a session key issued from said proxy server which is stored in a memory of said wireless device.

9. The method of claim 4 wherein said at least two authentication measures in step (c) include a biometric identification form.

10. The method of claim 4 wherein said at least two authentication measures in step (c) include a user-known authentication measure.

11. The method of claim 4 wherein steps (a) and (b) are performed via secure network connection to said proxy server.

12. The method of claim 4 wherein step (d) is performed via secure communication over an at least partially non-secure network.

13. The method of claim 4 including the further step of (e) receiving a session termination signal from said wireless device.

14. The method of claim 4 wherein step (a) includes the step of storing a user-associated private key on said proxy server.

15. A wireless communication system, comprising:
(a) a first data network for receiving and transmitting communications signals, comprising:
a proxy server for storing digital certificates and user metadata, said server being programmed to issue at least one session key so as to allow user access to said server via a wireless communications device, said proxy server being further programmed to receive communications from said device, determine the authority of said device to access information accessible to said proxy server and determine the authenticity of user information received from said wireless device;
at least one second server programmed to retrieve information and programming upon receipt of access and request information from said proxy server; and
a program for enabling said retrieved information and programming to be transmitted for suitable display on said wireless device;
and
(b) a second data network adapted to transmit to and receive signals from at least one wireless communications device, said device having a memory for storing at least one authentication measure.

16. The system of claim 15 wherein said access information received from said proxy server includes a digital certificate stored on said proxy server.

17. The system of claim 15 wherein said at least one authentication measure does not include a digital certificate, a portion of a digital certificate or a hash of a digital certificate.

18. The system of claim 17 wherein said at least one authentication measure further does not include a public or private key.

19. A wireless communication system, comprising:
a proxy server for storing user-associated information, including at least one digital certificate and at least one private key, said proxy server further being capable of issuing at least one authentication measure and accessing and transmitting secure information;
a wireless communication device having a memory and programming for transmitting and receiving communication signals, including authentication information; and
an initialization device for transmitting to said proxy server at least one digital certificate and a private key associated with a user, as well as information attributed to said wireless communication device, said initialization device further being capable of receiving an authentication measure issued by said proxy server and transmitting said authentication measure to a memory of said wireless device, said authentication measure not to include a digital certificate, a portion of a digital certificate or a hash of a digital certificate.

20. A wireless communications system, comprising:
a proxy server programmed to store device identification, digital certificate and credential information, and to provide access to information and programming requested by at least one other device;
a first programmable device being programmed for receiving a unique device identifier associated with a second programmable device and at least one user identifier and transferring said identifiers to said proxy server for authentication against said stored information on said proxy server, said first device further being programmed to exchange at least one authentication measure between said second programmable device and said proxy server and to transmit a digital certificate and at least one access credential associated with said at least one user to said proxy server,
said second programmable device being programmed so as to communicate remotely with said proxy server only upon providing said device identifier and said credential.

21. A computer readable memory, comprising:
programming for:
accessing and transmitting secure information within a network;
storing device and user-associated information; receiving and processing requests for initializing a wireless device for use in accessing secure information;
determining the authority of a device to request secure information;
determining the authenticity of information delivered via a wireless device in connection with a user having stored user-associated information;
receiving and processing requests received via a wireless device for secure information;
transmitting user-associated information in exchange for secure information based on said received requests for secure information; and
transmitting secure information to a wireless device.
